(19) United States
(12) Patent Application Publication
(10) Pub. No.: US 2011/0174424 A1
(43) Pub. Date: Jul. 21, 2011

(54) DEVICE AND METHOD FOR ATTACHING AN OPENING LEAF TO THE BODY OF A MOTOR VEHICLE

(75) Inventor: Michel Briault, Creteil (FR)

(73) Assignee: RENAULT S.A.S., Boulogne-Billancourt (FR)

(21) Appl. No.: 12/994,028

(22) PCT Filed: May 11, 2009
(86) PCT No.: PCT/FR2009/050856

§ 371 Date: Feb. 15, 2011

(30) Foreign Application Priority Data
May 23, 2008 (FR) 0853355

(51) Int. Cl. F16B 11/00; F16B 12/00; B32B 37/12; F16B 35/00

(52) U.S. Cl. 156/91; 403/265; 403/267

(57) ABSTRACT

A device for attaching a door leaf to an automobile body including: at least one plate combined with at least one hinge of the door leaf and mounted on a framework of the door leaf so that at least one screw connected to the plate interacts with a hole combined with the hinge and protrudes through the door leaf framework; a bonding mechanism provided between each plate and the door leaf framework, for making the position of each plate on the framework permanent during a paint processing of the door leaf framework; and an adjustable attachment mechanism for each plate so that each plate is mounted on the door leaf framework with a sliding mounting clearance for adjusting the position of each plate relative to the framework when the door leaf is mounted on the automobile body and before the paint processing.

### TECHNICAL FIELD OF THE INVENTION

The invention relates to a device for attaching an opening leaf to the body of a motor vehicle, said device comprising:
at least one panel, which is associated with at least one hinge of the opening leaf and is mounted on a framework of the opening leaf, such that at least one screw, which is integral with the panel, engages with an orifice associated with said hinge and protrudes through said framework of the opening leaf,
bonding means, which are placed between each panel and the framework of the opening leaf and are intended to make the position of each panel on the framework permanent during a painting treatment step of the framework of the opening leaf.

The invention also relates to a method of attaching an opening leaf to the body of a motor vehicle by means of an attachment device of this kind comprising at least one upper panel and one lower panel, which are each associated with a corresponding hinge of the opening leaf, the attachment method comprising at least the steps of:
attaching the upper panel and lower panel to a framework of the opening leaf by way of bonding means, which are placed between each panel and said framework and are intended to make the position of the panels on the framework permanent during a painting treatment step,
mounting the hinges on the opening leaf by means of screws, which are integral with each panel and protrude through the framework of the opening leaf,
attaching the hinges to the body of the vehicle and adjusting the position of the opening leaf with respect to the body of the vehicle.

### PRIOR ART

Conventionally, the hinges of a motor vehicle opening leaf, for example a side door, are attached to the framework of the opening leaf, for example a door casing, by way, in particular, of attachment panels, an upper panel, to which preferably two M8-type attachment screws are crimped or welded, and a lower panel, to which preferably one M8-type attachment screw is welded or crimped.

Once each panel has been mounted against the framework of the opening leaf, namely against the door casing, the attachment screws protrude through the casing and the panels are supported, for example, by plastic components. A first adjustment is then carried out during manufacture, more particularly during sheet metal work, in order to attach the hinges to the body of the vehicle. Next, the doors are removed to add the trim. In parallel, the hinges and door casing are treated together in a painting treatment step. Following the addition of trim, the trimmed doors are then remounted on the body of the vehicle and the panels have to be adjusted again with respect to the hinges.

However, such plastic components do not support the panels effectively on the door casing during the attachment of the hinges and the mounting of the door, and risk in particular dropping if they come into contact with the M8 screws, which are integral with the panels. Furthermore, an attachment method as described above requires two adjustment steps, a first step of adjusting the door without trim and a second adjusting step after the door has been provided with trim and the door casing has passed through the painting treatment.

In order for the upper and lower panels to be supported more effectively, one solution is to interpose a structural adhesive between the upper and lower panels and the door casing, that is to say bonding means for attaching the panels more effectively and preventing them from dropping, in particular during mounting on the hinges. A solution of this kind is described in particular in document U.S. Pat. No. 5,787,550, which describes a motor vehicle opening leaf hinge comprising a panel associated with bonding means, in the form of an adhesive patch, with a view to making it easier for the hinge to be supported with respect to the door casing. Furthermore, the panel is provided with a complementary positioning means, in the form of a hook, which is intended to engage with an orifice formed in the door casing with a view to prepositioning and attaching the panel with a slight vertical adjusting clearance.

However, such a hook system for attaching the panel has many drawbacks, in particular a complex manufacturing method for integrating the hook into the panel, and mounting which can come apart, since the hook can come out of the panel. Furthermore, a solution of this kind is not enough, in particular for dealing with the various problems associated with attaching the panels and adjusting the position of the panels with respect to the door casing.

### SUBJECT OF THE INVENTION

The aim of the invention is to remedy the abovementioned drawbacks, and it has the object of producing a device for attaching an opening leaf to the body of a motor vehicle, thereby improving the existing devices and making it possible to position and attach the hinges of the opening leaf in a simple, rapid and safe manner.

According to the invention, this aim is achieved by the appended claims and, more particularly, by the fact that the device comprises adjustable attachment means for each panel, such that each panel is mounted on the framework of the opening leaf with a sliding mounting clearance, enabling the position of each panel to be adjusted with respect to the framework during the mounting of the opening leaf on the body of the vehicle, before said painting treatment step.

Such a solution having adjustable and nonremovable attachment means thus provides a panel which is completely fixed with respect to the door casing and thus provides optimum attachment while still having an adjusting means.

Further advantages and features of the invention can be considered separately or in combination:
Each panel comprises a first mounting orifice, which is associated with a second orifice formed in the framework of the opening leaf, said first orifice and second orifice engaging with said adjustable attachment means.
The sliding mounting clearance is around 0.2 mm.
Said adjustable attachment means comprise a rivet associated with each panel.
The rivet is of the type in which the mandrel breaks.
The rivet has a head having a diameter of around 16.2 mm and a body having a maximum length of around 17.6 mm and a diameter of around 4.8 mm.
Said bonding means comprise at least one adhesive patch, of predetermined thickness and material, which is associated with each panel such that each patch melts by polymerization during said painting treatment step.
Said adhesive patch is approximately rectangular in form, having a thickness of around 0.4 mm, a length of around 40 mm and a width of around 16 mm.

The subject of the invention is also a method of attaching a motor vehicle opening leaf by means of such an attachment device, this method being simple to carry out and provides safe and rapid adjustment of the position of the opening leaf hinges.

This subject of the invention is characterized by the appended claims and, more particularly, by the fact that said step of attaching the panels is carried out with adjustable attachment means such that a sliding mounting clearance is left between the panels and the framework of the opening leaf with a view to adjusting the position of the panels with respect to the framework during the mounting of the opening leaf on the body of the vehicle, before said painting treatment step.

An attachment method of this kind thus eliminates an operation of adjusting the doors during mounting and ensures effective mounting right from the start.

### BRIEF DESCRIPTION OF THE DRAWINGS

Further advantages and features will become apparent more clearly from the following description of particular embodiments of the invention, which are given by way of nonlimiting example and are shown in the appended drawings, in which:

FIG. 1 schematically shows a partial exploded perspective view of a particular embodiment of a device for attaching a motor vehicle door according to the invention.

FIG. 2 schematically shows a front view in partial section of a particular step in an attachment method according to the invention, using an attachment device according to FIG. 1.

FIGS. 3 and 4 schematically show an upper panel of the attachment device according to FIGS. 1 and 2, mounted on a door casing and in an enlarged perspective view before mounting on the door casing, respectively.

FIGS. 5 and 6 schematically show a lower panel of the attachment device according to FIGS. 1 to 4, mounted on a door casing and in an enlarged perspective view before mounting on the door casing, respectively.

### DESCRIPTION OF THE PARTICULAR EMBODIMENTS

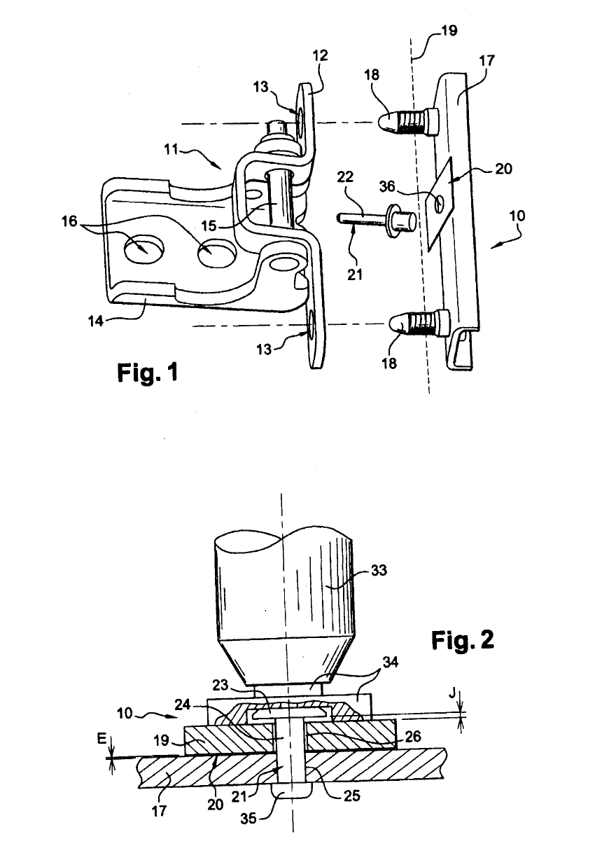

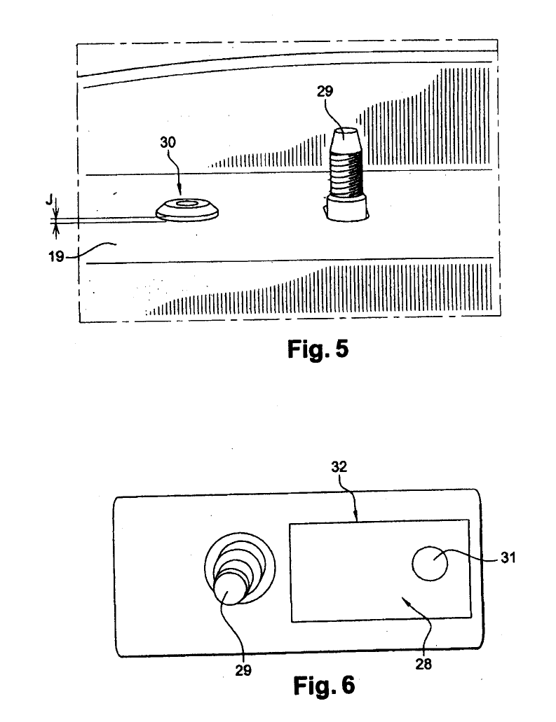

With reference to FIGS. 1 to 6, the attachment device 10 according to the invention is intended to attach an opening leaf, for example a side door or a trunk lid (or tailgate), to the body of a motor vehicle (not shown in the figures for reasons of clarity). In the particular embodiment shown in FIG. 1, only an upper hinge 11 of a motor vehicle side door, which is associated with an upper panel mounted on a framework of the door, is shown for reasons of clarity, the following description applying equally to a conventional lower hinge and to a lower panel (FIGS. 5 and 6).

In FIG. 1, the hinge 11 has conventionally a first bracket 12 which is pressed against a framework of the door, namely the door casing 19, and which comprises two attachment orifices 13. The attachment orifices 13 are, for example, oblong holes, so as to enable adjustment during the positioning of the hinge 11. The latter also has a second bracket 14, which is mounted such that it can rotate with respect to the first bracket 12 about a rotary pin 15 and is intended to be attached to the body of the vehicle. To this end, the second bracket 14 is provided, preferably, with two attachment buttonholes 16, which are for example approximately oblong.

In the particular embodiment shown in FIG. 1, the attachment device 10 according to the invention comprises an upper panel 17, which is provided towards its ends with two crimped or welded screws 18, which are integral with the panel 17 and are intended to engage with the orifices 13 in the first bracket 12 of the hinge 11.

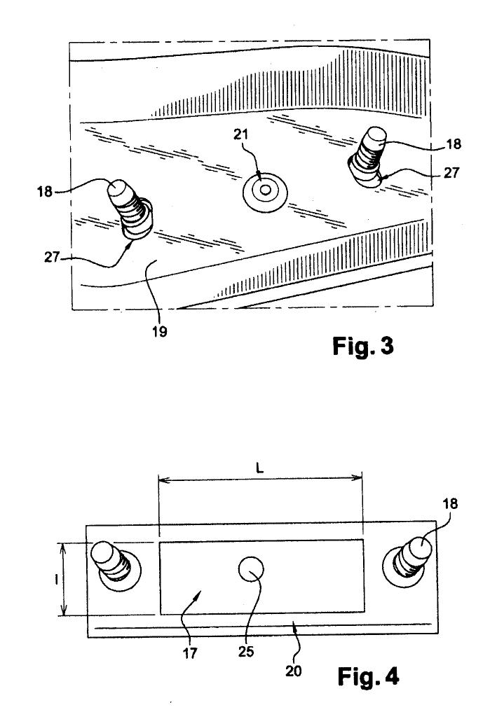

As shown schematically in FIG. 1, the upper panel 17 is positioned on one side of the door casing 19, represented schematically by a dotted line in FIG. 1, and the hinge 11 is positioned on the other side. Once the upper panel 17 has been mounted against the door casing 19, the screws 18 are intended to protrude through the door casing 19 (FIGS. 3 and 5).

In order to position the upper panel 17 against the door casing 19, the panel 17 is associated with bonding means, which take the form, for example, of an adhesive patch 20, of predetermined thickness and material, which is intended to make the position of the panel 17 permanent during a painting treatment step of the door casing 19. More particularly, the patch 20 is intended to melt by polymerization during a cataphoresis step, as described hereinbelow.

By way of example, the adhesive patch 20 is of the brand SAF6045TF from 3M. The adhesive patch 20 is preferably precut and has dimensions of around 16 mm in width 1 and 40 mm in length L for a thickness E of, for example, around 0.4 mm (FIGS. 2 and 4). Such an adhesive patch 20 is preferably made of a sticky structural material, which is perfectly suitable for slightly oily metal sheets, which are used in particular in sheet metal work, bodywork and mounting in the motor vehicle industry.

Furthermore, as shown in FIGS. 1 and 2, the attachment device 10 according to the invention preferably comprises a rivet 21 acting as adjustable means for attaching the upper panel 17 to the door casing 19. The rivet 21 is attached to the door casing such that the upper panel 17 is mounted, with respect to the casing, with a sliding mounting clearance J (FIG. 2), enabling adjustment of the position of the upper panel 17 with respect to the casing 19 and thus to the hinge 11 during the mounting of the latter on the body of the vehicle. The rivet 21 thus supports the panel 17 on the door casing 19, preventing the panel 17 from dropping during the manipulation of the hinge 11 and the mounting of the door or accidentally. By way of example, the rivet 21 is of the type in which the mandrel breaks, comprising a frangible mandrel 22 (FIG. 1), an approximately circular head 23 (FIGS. 1 to 6) and a body 24, or shaft, with an approximately circular cross section (FIG. 2).

By way of example, the head 23 of the rivet 21 has a diameter of around 16.2 mm, the body 24 of the rivet 21 has a maximum length before crimping (FIG. 1) of around 17.6 mm and the sliding mounting clearance J (FIG. 2) is around 0.2 mm.

As shown in more detail in FIG. 2, the upper panel 17 comprises a first mounting orifice 25, which is placed approximately in its center and engages with the body of the rivet 21, and the door casing 19 also comprises a second orifice 26, pierced through its thickness, which is associated with the body 24 of the rivet 21. The upper panel 17 is attached, for example, by way of a tool 33, preferably of the riveter type, which is equipped with a special mouthpiece 34 supporting the upper panel 17 and the door casing 19 such that the rivet 21 crimping operation leads to the characteristic appearance of a bead 35 and leaves the sliding mounting clearance J between the head 23 of the rivet 21 and the door casing 19 (FIG. 2).

As shown in more detail in FIGS. 3 and 4, once the panel 17 has been mounted and is supported by the rivet 21, the two screws 18 protrude through the door casing 19. In FIG. 3, the door casing 19 advantageously comprises mounting orifices 27, which are preferably oblong, in order to be able to adjust the position of the panel 17 in a simple manner with respect to the door casing 19.

In FIG. 4, which shows only the upper panel 17 provided with two crimped or welded screws 18, before mounting on the door casing 19, the position of the adhesive patch 20 is shown schematically by a black rectangle. The orifice 25, in which the rivet 21 is fixed, is placed approximately at the center of the panel 17, and the adhesive patch 20 thus also preferably comprises an orifice 36 (FIG. 1) for the insertion of the rivet 21.

In FIGS. 5 and 6, as indicated hereinabove, the attachment device 10 according to the invention also comprises a lower panel 28, which is associated with a lower hinge (not shown) of the door, said hinge being intended to be attached to the door casing 19. In the same way as above for the upper panel 17, the lower panel 28 is preferably provided with a single crimped or welded screw 29, which is intended to engage with a corresponding orifice in the lower hinge of the door and protrudes through the door casing 19 (FIG. 5).

In FIG. 5, the lower panel 28 is mounted on the door casing 19 by a rivet 30, which is mounted with the same sliding mounting clearance J as for the upper panel 17, so as to support the lower panel 28 against the door casing 19 and enable its position to be adjusted with respect to the door casing 19, as described hereinabove.

In FIG. 6, which shows only the lower panel 28 provided with the crimped or welded screw 29 before mounting on the door casing 19, the lower panel 28 comprises an orifice 31, which is intended to hold the body of the rivet 30. As above, the attachment device according to the invention also comprises an adhesive patch 32, represented schematically by a black rectangle in FIG. 6, which is interposed between the door casing 19 and the lower panel 28 and is intended to make the position of the lower panel 28 permanent during the cataphoresis treatment step, as described hereinbelow.

As described hereinabove, the attachment device 10 according to the invention, in particular by virtue of the rivets 21 and 30, thus enables the upper panel 17 and lower panel 28 to be attached in a sliding manner so that the position of the associated hinges 11 can be adjusted optimally with respect to the door casing 19. Similarly, the rivets 21, 30 constitute attachment means which make the associated panels 17, 28 captive with respect to the door casing 19 and make it easier to adjust and position them. Furthermore, the adhesive patches 20, 32 permanently set the position of the panels 17, 28 during the cataphoresis step. It is thus possible to remove and remount the doors without an additional adjusting step, as described hereinbelow.

A method of attaching a motor vehicle door by means of the attachment device 10 according to the invention, as described hereinabove, will be described in more detail with regard to FIGS. 1 and 2. The method according to the invention consists firstly in attaching the upper panel 17 and the lower panel 28 to the door casing 19 by means, first, of adhesive patches 20, 32 and, second, of rivets 21 and 30, with the sliding mounting clearance J. Next, the hinges 11 associated with the upper panel 17 and the lower panel 28 are mounted in an unclamped manner on the corresponding screws 18, 29 of the upper panel 17 and the lower panel 28, respectively.

The next step is the mounting of the door with attachment of the corresponding hinges 11 to the body of the vehicle. Finally, by virtue in particular of the rivets 21, 30, which play the role of adjustable attachment means, and of the associated oblong orifices 13, 27, a step of attaching and adjusting the final position of the door on the hinges and with respect to the body of the vehicle is carried out.

The assembly thus mounted and adjusted then passes into a painting treatment step, in particular by cataphoresis, making the position of the door permanent, by virtue in particular of the adhesive patches 20, 32, as described hereinabove. The door is then removed, without losing the adjusted position, and sent for a step of providing its body with trim, the door being remounted on the hinges without being adjusted again and without difficulty, the position of the upper panel 17 and the lower panel 28 having been made permanent by the polymerization of the adhesive patches 20, 32.

During the cataphoresis step, the product of the adhesive patches 20 and 32, which are associated with the upper panel 17 and the lower panel 28, passes through a semiliquid step, and with the temperature increasing it passes through a curing step and is transformed into a structural adhesive. By way of example, the mechanical strength of the structural glue thus obtained is around 15 MPa to 30 MPa. The cycle time for the cataphoresis is around three hours and the maximum temperature is around 190°.

An attachment method as described above thus makes it possible to dispense with an operation of adjusting the doors during mounting and to have effective mounting right from the start. The method is thus very simple to implement and reduces the time required therefor. The advantages connected with the simplicity and rapidity of implementing such a method make it possible to reduce the costs associated with the attachment operations and for the connection to be more resistant to corrosion. Furthermore, this method is safe and substantially limits the risks of a hinge attachment failing.

The invention is not limited to the various embodiments described hereinabove. The dimensions and forms of the bonding means and the adjustable attachment means are in particular nonlimiting and depend on the size of the upper panel and the lower panel, on the vehicle, on hinges, etc.

Further bonding means can be used, as long as they make the position of the panels permanent during the cataphoresis step. The rivets 21, 30 in which the mandrel breaks can be replaced with other adjustable attachment means, as long as they enable sliding mounting for adjusting the position of the panels during the mounting of the hinges of the opening leaf.

Furthermore, the opening leaf associated with the attachment device 10 can be a trunk lid, the upper panel and the lower panel then being attached to the lining of the trunk lid.

Generally, the invention applies to any type of opening leaf of any type of motor vehicle, comprising a device for attaching an opening leaf, as described hereinabove.

1-10. (canceled)

11. A device for attaching an opening leaf to a body of a motor vehicle, the device comprising:
at least one panel, which is associated with at least one hinge of the opening leaf and is mounted on a framework of the opening leaf, such that at least one screw, which is integral with the panel, engages with an orifice associated with the hinge and protrudes through the framework of the opening leaf;
bonding means placed between each panel and the framework of the opening leaf and configured to make the position of each panel on the framework permanent during a painting treatment of the framework of the opening leaf; and
an adjustable attachment means for each panel, such that each panel is mounted on the framework of the opening leaf with a sliding mounting clearance, enabling the position of each panel to be adjusted with respect to the framework during the mounting of the opening leaf on the body of the vehicle, before the painting treatment.

12. The device as claimed in claim 11, wherein each panel comprises a first mounting orifice, which is associated with a second orifice formed in the framework of the opening leaf, the first orifice and second orifice engaging with the adjustable attachment means.

13. The device as claimed in claim 11, wherein the sliding mounting clearance is around 0.2 mm.

14. The device as claimed claim 11, wherein the adjustable attachment means comprises a rivet associated with each panel.

15. The device as claimed in claim 14, wherein the rivet is of a type in which a mandrel breaks.

16. The device as claimed in claim 14, wherein the rivet includes a head having a diameter of around 16.2 mm and a body having a maximum length of around 17.6 mm and a diameter of around 4.8 mm.

17. The device as claimed in claim 11, wherein the bonding means comprises at least one adhesive patch, of predetermined thickness and material, which is associated with each panel such that each patch melts by polymerization during the painting treatment.

18. The device as claimed in claim 17, wherein the adhesive patch is approximately rectangular in form, having a thickness of around 0.4 mm, a length of around 40 mm and a width of around 16 mm.

19. A method of attaching an opening leaf to the body of a motor vehicle by an attachment device as claimed in claim 17, the device comprising at least one upper panel and one lower panel, which are each associated with a corresponding hinge of the opening leaf, the attachment method comprising:
attaching the upper panel and lower panel to a framework of the opening leaf by bonding means placed between each panel and the framework and that are configured to make a position of the panels on the framework permanent during a painting treatment;
mounting the hinges on the opening leaf by screws, which are integral with each panel and protrude through the framework of the opening leaf;
attaching the hinges to the body of the vehicle and adjusting the position of the opening leaf with respect to the body of the vehicle;
wherein attaching the panels is carried out with an adjustable attachment means such that a sliding mounting clearance is left between the panels and the framework of the opening leaf with a view to adjusting the position of the panels with respect to the framework during the mounting of the opening leaf on the body of the vehicle, before the painting treatment.

20. The method as claimed in claim 19, wherein the painting treatment is performed by cataphoresis, causing polymerization of the bonding means.
